(19) United States
(12) Patent Application Publication
(10) Pub. No.: US 2011/0314273 A1
(43) Pub. Date: Dec. 22, 2011

(54) DATA GRADING TRANSMISSION METHOD

(75) Inventors: Pao Chuan Chu, Taipei (TW); Hsiu-Hsien Li, Taipei (TW); Li-Chen Lai, Taipei (TW); Liang-Chuan Lin, Taipei (TW); Ming Chung, Taipei (TW); Shou-Yi Chen, Taipei (TW); Shis-Kai Chang, Taipei (TW); Pei-Chun Chen, Taipei (TW); Tsan-Hua Chuang, Taipei (TW)

(73) Assignee: CHUNGHWA TELECOM CO., LTD., Taipei (TW)

(21) Appl. No.: 12/904,806

(22) Filed: Oct. 14, 2010

(30) Foreign Application Priority Data
Jun. 18, 2010 (TW) 099119825

(51) Int. Cl. H04L 9/00

(52) U.S. Cl. 713/153; 726/11

(57) ABSTRACT

A data grading transmission method includes steps of enabling a transmitting terminal to grade data according to a preset data security rule and to mark the data with labels; designating transmission routes of the data according to levels of the graded data; and enabling the data to be transmitted from the transmitting terminal to the receiving terminal through the designated transmission routes, and cascading the data having the same label according to the labels of the data. Thereby, grading data according to privacy and designating transmission routes of data reduce network establishment cost and effectively regulate data transmission rate through the data grading transmission method.

### BACKGROUND OF THE INVENTION

1. Field of the Invention

This invention relates to data grading transmission techniques, and more particularly, to a data grading transmission method applicable for private network and public network.

2. Description of Related Art

With advance of Internet technology, a cloud concept spreads the whole society. Opening a Gmail account, sharing photos in Wretch or Flicker by albums, uploading and downloading all kinds of software by iPhone, or logging in Facebook all relate the cloud concept, for instance, cloud storage, cloud calculation, etc.

The cloud concept not only changes personal life but also enormously effects data processing mode, for instance, data storage, calculation, and transmission, of enterprises or government agencies. Most of general enterprises establish network architecture having private cloud in order to simultaneously enjoy effect of cloud concept and protect inner confidential data of enterprises. However, required bandwidth and establishment cost of private cloud increase along with gradually doubling text and image data.

For example, an objective of establishment of Health Information Network (HIN) is to establish well health information network environment, so as to provide information transmission service of medical institutions, health insurance institutions, and health administration institutions, etc. In recent years, Information Center of Department of Health further considers to plan that Health Information Network uses Government Service Network (GSN) according to aspect of bandwidth efficiency, cost benefit, information security, and maintenance management of network application service, and future network application service requirement of overall HIN. Thus, Department of Health establishes a private cloud network for maintaining personal medical information privacy instead of a public cloud network. However, personal case history of medical data requires high privacy, and other data having nothing to do with privacy require low privacy relatively. Unnecessary data protecting measure not only reduces transmission rate of overall data but also increases establishment cost of private cloud if using the same confidential processing treatment having high standard to performing transmission.

Moreover, in terms of the previously described cloud network technology, since government agencies or enterprises establish private cloud network according to each requirement, user management is difficult, and professional firms are needed to guiding encryption and monitoring of global network when enormous key switching is performed during communication between cloud and cloud. Additionally, as illustrated previously, all data using the same encryption technology or encryption transmission technology without performing grading according to confidential level would lead to that a manager does not understand the location of failure point, and to difficult maintenance.

Hence, the current problem to be solved is that how to provide a data transmission method for public cloud network or private cloud network.

### SUMMARY OF THE INVENTION

In view of the above-mentioned problems of the prior art, a data grading transmission method which may decrease cost, time, and difficulty of data transmission network establishment or management is provided according to the present invention.

The data grading transmission method in accordance with the present invention is applied between a transmitting terminal and a receiving terminal, the transmitting terminal transmitting data to the receiving terminal via a public network and/or a private network. The data grading transmission method comprises steps of: (a) enabling the transmitting terminal to grade the data according to a preset data security rule and to mark the data with labels which are used to distinguish levels of the data; (b) enabling the transmitting terminal to designate transmission routes of the data according to the labels of the data; and (c) enabling the data to be transmitted from the transmitting terminal to the receiving terminal through the designated transmission routes, and enabling the receiving terminal to cascade the data having the same label according to the labels of the data.

Moreover, a transmission route of first-level data in accordance with the data grading transmission of the present invention is defined to be an exclusive channel established from the transmitting terminal to the receiving terminal. A transmission method of the first-level data comprises steps of: (a) performing packet encryption with respect to the first-level data; (b) performing packet network address translation with respect to the first-level data; and (c) transmitting the first-level data from the transmitting terminal to the receiving terminal via the exclusive channel, wherein the exclusive channel is closed after the first-level data enters the exclusive channel.

Moreover, a transmission route of second-level data in accordance with the data grading transmission of the present invention is defined to be an encrypted channel established in the public network. A transmission method of the second-level data comprises steps of: (a) performing packet encryption with respect to the second-level data; (b) performing packet network address translation with respect to the second-level data; and (c) transmitting the second-level data from the transmitting terminal to the receiving terminal via the encrypted channel, wherein the encrypted channel is closed after the second-level data enters the encrypted channel.

Moreover, a transmission route of third-level data in accordance with the data grading transmission of the present invention is defined to be a virtual channel established in the public network. A transmission method of the third-level data comprises steps of: (a) performing packet network address translation with respect to the third-level data; and (b) transmitting the third-level data from the transmitting terminal to the receiving terminal via the virtual channel, wherein the virtual channel is closed after the third-level data enters the virtual channel.

In contrast with the prior art, the present invention grades the data which are ready to be transmitted, so as to enable the data having a lower security level not to occupy the private network acting as the exclusive channel. Additionally, grading the data while labeling the data enables the receiving terminal to cascade and combine the data having the same label after receiving the data from ports of different channels, thereby reducing required bandwidth and establishment cost of the exclusive channel.

### BRIEF DESCRIPTION OF DRAWINGS

The invention can be more fully understood by reading the following detailed description of the preferred embodiments, with reference made to the accompanying drawings, wherein:

FIG. 1 is a flow chart of a data grading transmission method in accordance with the present invention;

FIG. 2 is a flow chart of the data grading transmission method in accordance with a more specific implementation aspect of the present invention; and

FIG. 3 is a schematic diagram of the data grading transmission method in accordance with a specific implementation aspect of the present invention.

### DETAILED DESCRIPTION OF PREFERRED EMBODIMENTS

The following illustrative embodiments are provided to illustrate the disclosure of the present invention. These and other advantages and effects of the present invention can be apparently understood by persons having ordinary skill in the art after reading the disclosure of this specification.

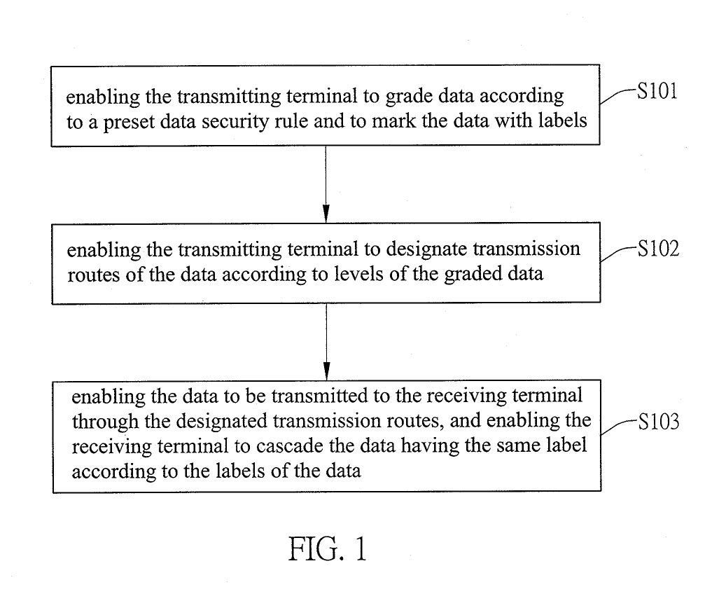

Please refer to FIG. 1 illustrating a flow chart of a data grading transmission method in accordance with the present invention. It must be explained that a transmitting terminal and a receiving terminal described in this specification comprises text data, image data, or voice data, in terms of data and are mechanisms for switching packets between the two terminals in terms of packets.

In a step S101, the transmitting terminal is enabled to grade data according to a preset data security rule and to mark the graded data with labels which are used to distinguish levels of the data. In a specific implementation aspect, the data may be graded to first-level data (extremely confidential data), second-level data (confidential data), and third-level data (general data) according to security or privacy levels. Grading means are not limited to packet type, or software or hardware equipments and may even be performed according to user identity, key words contained in data content, and data property of the receiving terminal. Moreover, the data transmitted from the same transmitting terminal may be marked with the same label, for instance, a string added into the packet header of the data or a primary key added into the packet content of the data, so as to be distinguished by the receiving terminal. Then, a step S102 is executed.

In the step S102, a transmission route of the data is designated by the transmitting terminal according to the labels of the data. Specifically, the data having different levels are set to be transmitted via specific transmission routes. For example, the extremely confidential data, the confidential data, and the general data may correspondingly pass through specific transmission channels and then arrive the receiving terminal. These channels are distributed in the public network and/or private network, wherein the public network is, for instance, Internet, and the private network may be private cloud architectures established by each enterprise. Next, a step S103 is executed.

In the step S103, the data is transmitted from the transmitting terminal to the receiving terminal through the designated transmission routes, and the receiving terminal is enabled to cascade the data marked with the same label according to the labels of the data. The receiving terminal may cascade and combine the data having the same label after receiving the data from ports of different channels, so as to recover the data delivered from the transmitting terminal.

Known from the previously description, the data grading transmission method of the present invention enables the data having different levels to be transmitted through different channels by grading the data transmitted from the transmitting terminal. Hence, key exchange is unnecessary for access of the public network or the private network, so as to decrease load of data transmission and data security management. Furthermore, grading the data having different levels by route design may reduce cost of private network establishment or management.

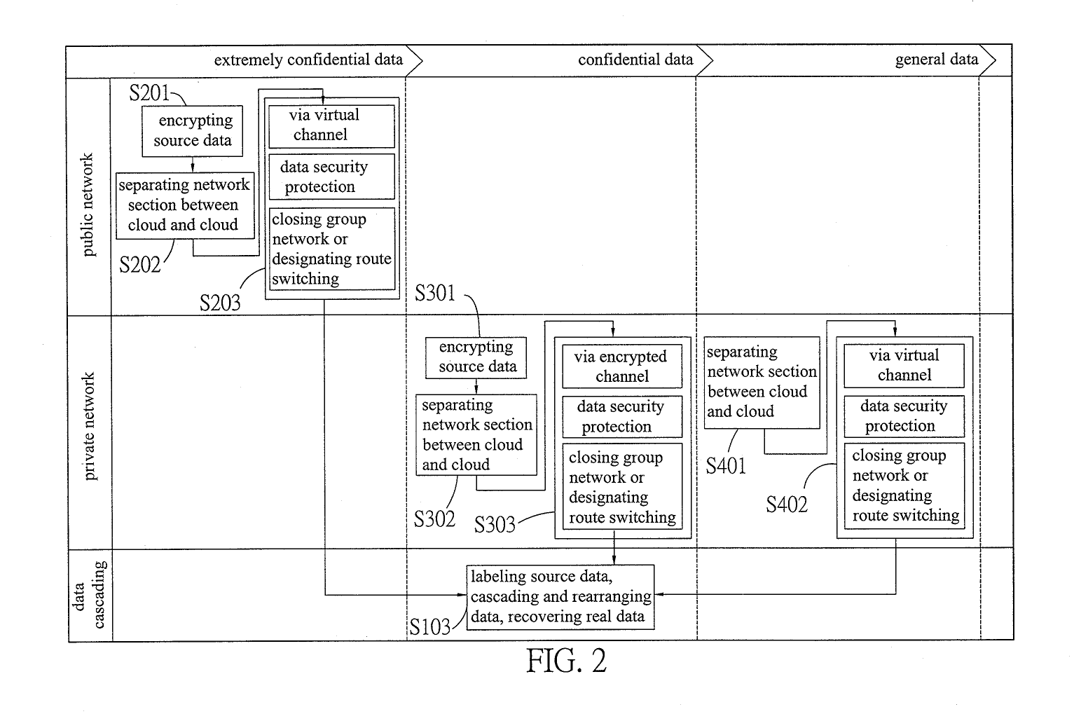

Next, with reference to FIG. 2, it is a flow chart of the data grading transmission method in accordance with a specific implementation aspect of the present invention. As illustrated, in the specific implementation aspect, network may roughly be classified to the private network and the public network, and the data may be graded to the extremely confidential data, the confidential data, and general data. The transmission route of the extremely confidential data is an exclusive channel established from the transmitting terminal to the receiving terminal, wherein steps S201˜S203 are transmission methods of the extremely confidential data. The transmission route of the confidential data is an encrypted channel established in the public network, wherein steps S301˜S303 are transmission methods of the confidential data. The transmission route of the general data is a virtual channel established in the public network, wherein steps S401˜S402 are transmission methods of the general data.

In the step 201, packet encryption is performed with respect to the extremely confidential data, wherein the packet encryption may be executed via software or hardware, or by ISP enterprises adding encryption algorithm in a system. Next, the step S202 is executed.

In the step S202, packet network address translation (NAT) is performed with respect to the extremely confidential data. Specifically, IP switching is necessary when the data transmits between cloud and cloud, otherwise, contributing to address repeating and invalid transmission. Next, the step S203 is executed.

In the step S203, the extremely confidential data are transmitted from the transmitting terminal to the receiving terminal via the exclusive channel and a data security protecting mechanism, wherein the exclusive channel is closed, or the receiving terminal is enabled to perform packet switching with the transmitting terminal after the extremely confidential data enter the exclusive channel. Specifically, the exclusive channel means that an exclusive circuit, for instance, Virtual Private Network (VPN) or Government Service Network (GSN) VPN, from the transmitting terminal to the receiving terminal is provided, and the data security protecting mechanism may be, but not limited to, FireWall (FW) server, Internet Service Provider (IPS), or Anti-Virus (AV) server, etc. Next, the step S103 described previously is executed.

In the step 301, packet encryption is performed with respect to the confidential data. Next, the step S302 is executed.

In the step S302, packet network address translation is performed with respect to the confidential data. Next, the step S303 is executed.

In the step S303, the confidential data are transmitted from the transmitting terminal to the receiving terminal via the encrypted channel and the data security protecting mechanism, wherein the encrypted channel is closed, or the receiving terminal is enabled to perform packet switching with the transmitting terminal after the confidential data enter the encrypted channel. Specifically, since the confidential data has a safety level of lower than that of the extremely confidential data, bandwidth of the private network is unnecessarily to be occupied. Hence, a packet of the public network outside the encrypted channel is refused to enter the encrypted channel established in the public network by Generic Routing Encapsulation (GRE) technology and Internet Protocol Security (IPSEC). An effect in terms of the encrypted channel is achieved that a packet of the confidential data enters and does not come out of it. Next, the step S103 described previously is executed.

In the step S401, packet network address translation is performed with respect to the general data. Next, the step S402 is executed.

In the step S402, the general data are transmitted from the transmitting terminal to the receiving terminal via the virtual channel and the data security protecting mechanism, wherein the virtual channel is closed, or the receiving terminal is enabled to perform packet switching with the transmitting terminal after the general data enter the virtual channel. Specifically, the general data often do not involve too much individual privacy, and hence may arrive the receiving terminal via the virtual channel, for instance, VPN or GSN VPN (which differ from physical network cable of the exclusive channel used by the extremely confidential data), which uses tunneling technology. Next, the step S103 described previously is executed.

At last, the described receiving terminal receives the extremely confidential data, the confidential data, and the general data from ports of the exclusive channel, the encrypted channel, and the virtual channel, respectively. As illustrated in the step S103 of FIG. 1, the receiving terminal is enabled to cascade the data marked with the same label according to the labels of the data, so as to recover the data transmitted from the transmitting terminal.

Attentively, FIG. 2 illustrates that the data are transmitted from the transmitting terminal to the receiving terminal, and labels provided on the data are the same, so as to enable the receiving terminal to distinguish the data transmitted from the transmitting terminal when the receiving terminal receives the data. In other words, labels provided on data transmitted from different transmitting terminal are also different, so as to supply for the receiving terminal to distinguish the data.

Known from the more detailed flow chart illustrated in FIG. 2, the general data having no personal information may be transmitted via the existing public network, for instance, Internet, the extremely confidential data having personal information are transmitted by establishing low-speed private cloud, and the two are cascaded in the receiving terminal via a common label. Therefore, the data grading transmission method of the present invention effectively decreases overall establishment cost. Such a network clustering mode is easier to be inquired and maintained, and avoids condition of single failure point. Moreover, application of the exclusive channel, the encrypted channel, and the virtual channel may decrease wait time of data transmission and increase work speed.

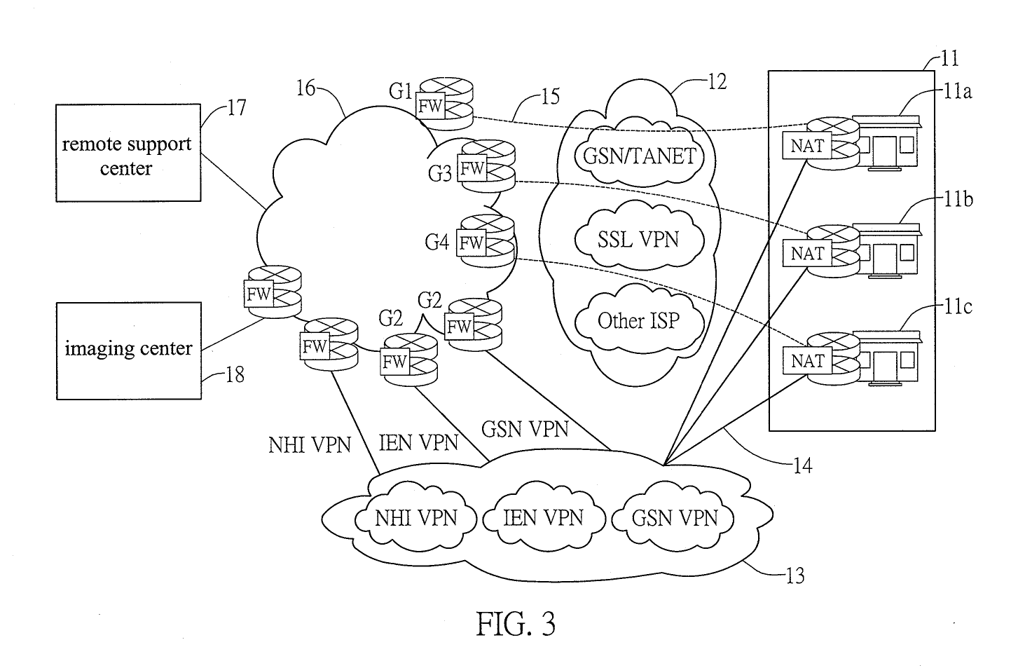

Particularly, please referring to FIG. 3, the data grading transmission method of the present invention is applied to transmit the data from the transmitting terminal 11 to the receiving terminal 16 via the public network 12 and/or the private network 13. It should be explained that FIG. 3 just illustrates, but does not limit to, the exclusive channel 14 of the private network 13 and the encrypted channel 15 of the public network 12 in accordance with the present invention.

In the implementation aspect, the transmitting terminal 11 may be a public hospital medical center 11a, a clinic 11b, or a private hospital medical center 11c. Generally, an electronic case history of a patient comprises text data and image data, for instance, Computed Tomography (CT), Magnetic Resonance Imaging (MRI), Position Emission Tomography (PET), X-ray equipment, etc. It contributes to not only transmission delay of the text data but also shortage bandwidth of the private network 13 if the text data and these enormous image data are transmitted simultaneously via the private network 13. Hence, electronic data of patients could be graded to the extremely confidential data and the confidential data via the data grading transmission method of the present invention, wherein the extremely confidential data are the text data having personal information of a patient which does not need high-speed network, while the confidential data are the previously described image data having no apparent personal information of a patient which needs enormous bandwidth.

As illustrated, the encrypted channel 15 is divided in the public network 12 for the public hospital medical center 11a, the clinic 11b, and the private hospital medical center 11c to transmit patient data, wherein the encrypted channel 15 may be through, for instance, Government Service Network (GSN)/Taiwan Academic Network (TANET), Secure Socket Layer (SSL) VPN, or other Internet Service Provider (ISP). And the exclusive channel 14 from the transmitting terminal to the receiving terminal is supplied by the private network 13, wherein the exclusive channel 14 may be, for instance, National Health Insurance (NHI) VPN, Intelligent Energy Network (IEN) VPN, or Government Service Network (GSN) VPN, and practically an exclusive circuit line for a remote support center 17 and an imaging center 18 to receive patient data via network. The receiving terminal 16 may comprises, but does not be limited to, plural gates G1˜G6 and plural FireWall (FW).

Therefore, the clinic 11b may receive the image data transmitted from the public/private hospital medical center 11a, 11c, or the imaging center 18 in a short time during inquiry process of doctors in the clinic 11b, so as to conduct diagnosis of patients and increase treatment efficiency while medical privacy of patients is considered. Correspondingly, if case history data preserved in the public/private hospital medical center 11a or 11c are needed, they would be transmitted to the clinic 11b via the exclusive channel 14 of the previously described private network 13.

In conclusion, the data grading transmission method of the present invention may provide the transmission routes having different network security levels, use different encryption and decryption transmission technology according to secret levels of the data, so as to achieve network clustering management and maintenance, decrease incidence of single failure point, and further rapidly exclude the failure point and problems, thereby reducing required bandwidth and cost, time, and difficulty of establishment of the private network acting as the exclusive channel. Moreover, labeling these data while grading the data enables the receiving terminal to may cascade and combine the data having the same label after the receiving terminal receives the data from different ports of channels, so as to recover the data transmitted from the transmitting terminal. Hence, wait time of data transmission is decreased and data security is considered via combined application of the public network, private network, and establishment of the exclusive channel, the encrypted channel, and the virtual channel.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A data grading transmission method applicable between a transmitting terminal and a receiving terminal, the transmitting terminal transmitting data to the receiving terminal via a public network and/or a private network, the method comprising the steps of:
(a) enabling the transmitting terminal to grade the data according to a preset data security rule and to mark the data with labels which are used to distinguish levels of the data;
(b) enabling the transmitting terminal to designate transmission routes of the data according to the labels of the data; and
(c) enabling the data to be transmitted from the transmitting terminal to the receiving terminal through the designated transmission routes, and enabling the receiving terminal to cascade the data having the same label according to the labels of the data.

2. The method of claim 1, wherein the step of marking the data with the labels comprises adding a string into packet header of the data or a primary key into packet content of the data.

3. The method of claim 1, wherein the step of enabling the transmitting terminal to grade the data comprises grading the data to be first-level data, second-level data, and third-level data.

4. The method of claim 3, wherein step (c) further comprises defining a transmission route of the first-level data to be an exclusive channel established from the transmitting terminal to the receiving terminal, and wherein step (c) further comprises the steps of:
(c1) performing packet encryption with respect to the first-level data;
(c2) performing packet network address translation with respect to the first-level data; and
(c3) transmitting the first-level data from the transmitting terminal to the receiving terminal via the exclusive channel, and closing the exclusive channel after the first-level data enter the exclusive channel.

5. The method of claim 4, wherein step (c3) further comprises enabling the first-level data to be transmitted via the exclusive channel and a data security protecting mechanism to the receiving terminal.

6. The method of claim 4, wherein step (c3) further comprises enabling the receiving terminal to perform packet switching with the transmitting terminal after the first-level data enter the exclusive channel.

7. The method of claim 3, wherein step (c) further comprises defining a transmission route of the second-level data to be an encrypted channel established in the public network, and wherein step (c) further comprises the steps of:
(c1) performing packet encryption with respect to the second-level data;
(c2) performing packet network address translation with respect to the second-level data; and
(c3) transmitting the second-level data from the transmitting terminal to the receiving terminal via the encrypted channel, and closing the encrypted channel after the second-level data enter the encrypted channel.

8. The method of claim 7, wherein the encrypted channel is established by Generic Routing Encapsulation technology and Internet Protocol Security.

9. The method of claim 7, wherein step (c3) further comprises enabling the second-level data to be transmitted via the encrypted channel and a data security protecting mechanism to the receiving terminal.

10. The method of claim 7, wherein step (c3) further comprises enabling the receiving terminal to perform packet switching with the transmitting terminal after the second-level data enter the encrypted channel.

11. The method of claim 3, wherein step (c) further comprises defining a transmission route of the third-level data to be a virtual channel established in the public network, and wherein step (c) further comprises steps of:
(c1) performing packet network address translation with respect to the third-level data; and
(c2) transmitting the third-level data from the transmitting terminal to the receiving terminal via the virtual channel, and closing the virtual channel after the third-level data enter the virtual channel.

12. The method of claim 11, wherein step (c2) further comprises enabling the third-level data to be transmitted via the virtual channel and a data security protecting mechanism to the receiving terminal.

13. The method of claim 11, wherein step (c2) further comprises enabling the receiving terminal to perform packet switching with the transmitting terminal after the third-level data enter the virtual channel.
